(19) United States
(12) Patent Application Publication
(10) Pub. No.: US 2013/0040070 A1
(43) Pub. Date: Feb. 14, 2013

(54) METHOD FOR FORMING MICROSTRUCTURE PATTERN BASED ON SOLUTION PROCESS

(71) Applicants: Gun Young JUNG, Gwangju (KR); Kwang-Ho LEE, Gwangju (KR)

(72) Inventors: Gun Young JUNG, Gwangju (KR); Kwang-Ho LEE, Gwangju (KR)

(73) Assignee: GWANGJU INSTITUTE OF SCIENCE AND TECHNOLOGY, Gwangju (KR)

(21) Appl. No.: 13/325,711

(22) Filed: Dec. 14, 2011

(30) Foreign Application Priority Data
Aug. 8, 2011 (KR) 10-2011-0078491

(51) Int. Cl. C08J 7/18

(52) U.S. Cl. 427/553

(57) ABSTRACT

Disclosed is a method for forming a microstructure pattern based on a solution process. The method includes the steps of forming a photoresist pattern on a hydrophilic substrate; forming a self-assembled monolayer on the hydrophilic substrate formed thereon with the photoresist pattern; forming a self-assembled monolayer pattern by removing the photoresist pattern; coating a dewetting solution on the hydrophilic substrate formed thereon with the self-assembled monolayer pattern such that the dewetting solution is coated only on a hydrophilic surface of the hydrophilic substrate exposed through the self-assembled monolayer pattern by primary dewetting; and drying the dewetting solution coated on the hydrophilic surface of the hydrophilic substrate and allowing the dewetting solution to be hardened after flowing to an edge of the dewetting solution by secondary dewetting such that only a solute of the dewetting solution remains.

### CROSS-REFERENCE TO RELATED APPLICATION

This application claims the benefit under 35 U.S.C. §119 of Korean Patent Application No. 10-2011-0078491, filed on Aug. 8, 2011 in the Korean Intellectual Property Office, the entirety of which is incorporated herein by reference.

### BACKGROUND OF THE INVENTION

1. Field of the Invention

The present invention relates generally to a method for forming a microstructure pattern based on a solution process. More particularly, the present invention relates to a method for forming a microstructure pattern based on a solution process by using the double-dewetting edge lithography (DDEL).

2. Description of the Related Art

Since last several decades, many researchers have endeavored to develop the inexpensive and simple patterning technology. The conventional patterning technology, such as the photolithography and the metal deposition system, has been extensively used in the modern electronic industries for the purpose of mass-production of micro and nano-scale patterns.

In the modern industrial society, there is tendency to change inorganic devices into organic devices and various functional polymer solutions have been developed. However, if the conventional photolithography technology is applied to the organic devices, a lower organic layer may be damaged when the lift-off process employing UV exposure and a solvent is performed. In order to solve the above problem, various technologies based on the solution process have been developed. For instance, direct solution patterning methods, such as micro-contact printing (CP), dewetting, ink-jet printing and screen printing, have been developed.

Among them, a study has been actively performed to form a microstructure pattern on a thin film formed on a substrate by using the dewetting phenomenon.

However, various problems are represented still now, such as complicated processes and expensive equipment.

For instance, according to the conventional method for forming the microstructure pattern by using the dewetting phenomenon, a thin film pattern is formed on a substrate by performing a heat treatment process at a predetermined temperature range after applying high pressure to a PDMS template such that the PDMS template makes contact with the substrate.

Thus, the conventional method requires specific process conditions, such as the high pressure and the predetermined temperature, and lengthens the process time.

Reference:

1) Gang Shi et al., Fabrication of TiO₂ Arrays Using Solvent-Assisted Soft Lithography, Langmuir 2009, 25(17), 9639-9643.

### SUMMARY OF THE INVENTION

Accordingly, the present invention has been made keeping in mind the above problems occurring in the prior art, and an object of the present invention is to provide a method for forming a microstructure pattern based on a solution process by using the double-dewetting edge lithography (DDEL), which can be performed at the normal temperature and can shorten the process time.

To accomplish the above object, according to one aspect of the present invention, there is provided a method for forming a microstructure pattern, which includes the steps of farming a photoresist pattern on a hydrophilic substrate; forming a self-assembled monolayer on the hydrophilic substrate formed thereon with the photoresist pattern; forming a self-assembled monolayer pattern by removing the photoresist pattern; coating a dewetting solution on the hydrophilic substrate formed thereon with the self-assembled monolayer pattern such that the dewetting solution is coated only on a hydrophilic surface of the hydrophilic substrate exposed through the self-assembled monolayer pattern by primary dewetting; and drying the dewetting solution coated on the hydrophilic surface of the hydrophilic substrate and allowing the dewetting solution to be hardened after flowing to an edge of the dewetting solution by secondary dewetting such that only a solute of the dewetting solution remains.

To accomplish the above object, according to another aspect of the present invention, there is provided a method for forming a microstructure pattern, which includes the steps of forming a self-assembled monolayer pattern on a hydrophilic substrate; coating a dewetting solution on the hydrophilic substrate exposed through the self-assembled monolayer pattern; and drying the dewetting solution such that only a solute of the dewetting solution remains on a region making contact with the self-assembled monolayer pattern.

The hydrophilic substrate may include Ag, Au, Cu, Pd, Ti, Si, SiO₂, Al₂O₃ or ITO (Indium Tin Oxide).

A self-assembled mono-molecule of the self-assembled monolayer pattern may include a silane group or a thiol group as a head group.

The self-assembled mono-molecule of the self-assembled monolayer pattern may include OTS (octadecyltrichlorosilane) or HDT (hexadecanethiol).

The solute of the dewetting solution may include a polymer, a biomaterial or a metal nano-particle.

The polymer may include at least one selected from the group consisting of PMMA, PVA, PS, PVP, P3HT, PQT-12, F8T2 and TIPS-pentacene.

The biomaterial may include at least one selected from the group consisting of a nucleic acid, a cell, a virus, a protein, an organic molecule, and an inorganic molecule.

The metal nano-particle may include at least one selected from the group consisting of Ag, Au, Cu, Pd and Ti.

The coating of the dewetting solution only on the hydrophilic surface of the hydrophilic substrate is carried out at a normal temperature.

As described above, according to the present invention, the double-dewetting edge lithography (DDEL) is a solution patterning process capable of simply patterning the microstructure through the photolithography and the SAM (self-assembled monolayer) treatment, and the process has been completed within 1 second at the normal temperature, so the economic efficiency can be improved. In addition, it is possible to form the microstructure pattern having various structures, such as a ring structure, a right-angle structure, a triangle structure, and a linear structure. In addition, the ultra-micro patterning with a nano-scale is possible in the micro-scale structure, such as a photoresist.

The effects of the present invention may not be limited to the above effects, and other effects of the present invention may be comprehended to those skilled in the art from the following description.

### BRIEF DESCRIPTION OF THE DRAWINGS

FIGS. 1a to 1g are sectional views showing the manufacturing procedure for forming a microstructure pattern according to one embodiment of the present invention;

FIGS. 2a to 2f are snapshot images representing a process for forming a microstructure pattern according to one embodiment of the present invention based on the time sequence;

FIGS. 3a to 3d are images and a graph representing the result of a microstructure pattern according to the type of solvent;

FIGS. 4a to 4d are images and a graph representing the result of a microstructure pattern according to the drying temperature;

FIGS. 5a to 5f are images and a graph representing the result of a microstructure pattern according to concentration of a solution; and

FIG. 6 is an image showing various microstructure patterns formed through the double dewetting edge lithography.

### DETAILED DESCRIPTION OF THE INVENTION

Hereinafter, exemplary embodiments of the present invention will be described with reference to accompanying drawings. The present invention is not limited to the following embodiments, but can be embodied in various forms and includes various equivalents and substitutes within the technical scope of the present invention. The embodiments will make the disclosure of the present invention complete, and allow those skilled in the art to completely comprehend the scope of the present invention. The thickness of layers and regions in the drawings may be exaggerated for the purpose of clarity and the same reference numerals will be used to refer to the same elements throughout the specification. If it is determined that description about well known functions or configurations may make the subject matter of the present invention unclear, the details thereof will be omitted.

In the following description of the present invention, a term “normal temperature” refers to the natural temperature in the level of about 23° C. without heating or cooling.

### Embodiment 1

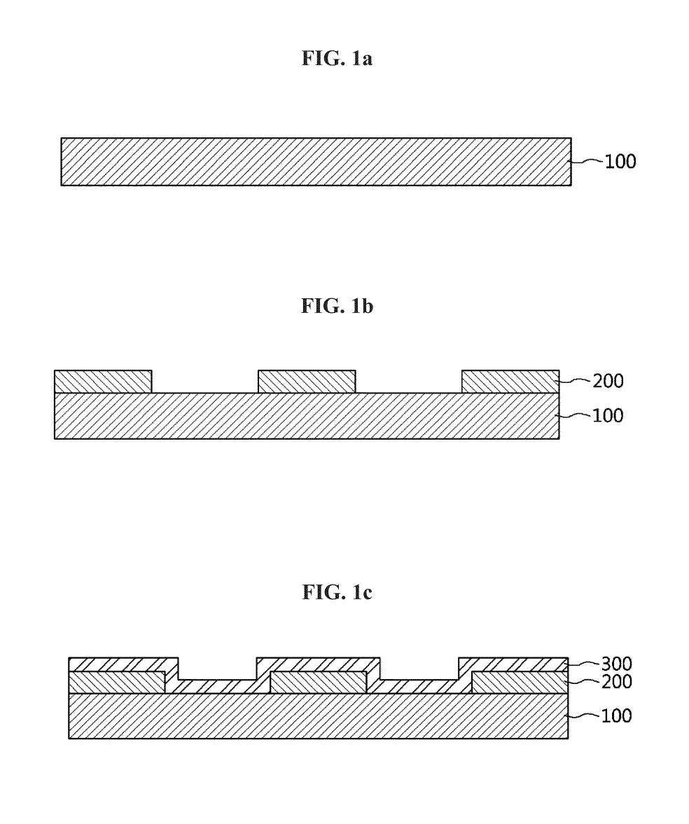

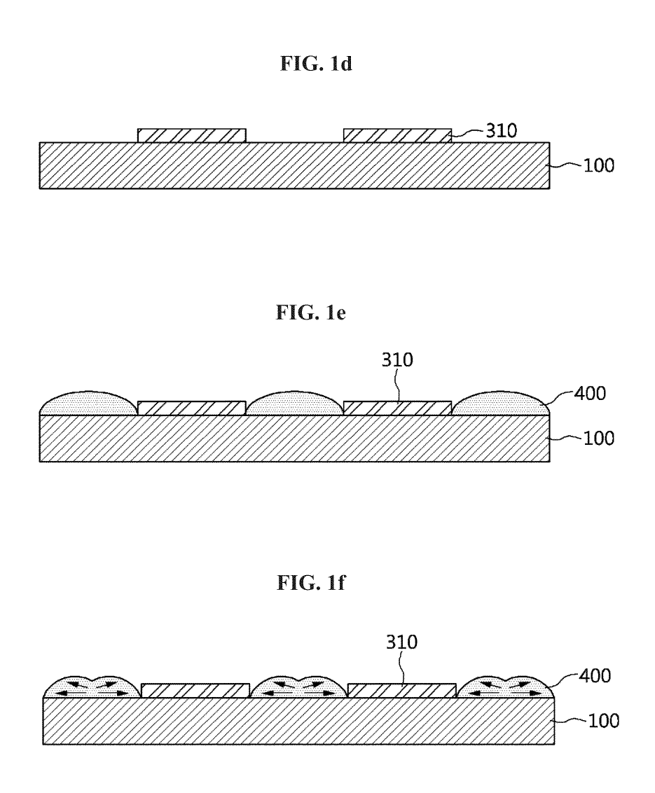

FIGS. 1a to 1g are sectional views showing the manufacturing procedure for a microstructure pattern according to one embodiment of the present invention.

Referring to FIG. 1a, a substrate 100 is prepared.

The substrate 100 may include Ag, Au, Cu, Pd, Ti, Si, SiO₂, Al₂O₃ or ITO (Indium Tin Oxide), but the present invention is not limited thereto.

A surface of the substrate 100 is subject to the hydrophilic treatment. In detail, the surface of the substrate 100 may be subject to the acidic treatment or the basic treatment. If the substrate 100 is a hydrophilic substrate, the hydrophilic treatment may be omitted.

If the substrate 100 is an oxide-based substrate, the substrate 100 is subject to the acidic treatment to impart the OH radical to the substrate 100. In addition, if the substrate 100 is a metal substrate, the substrate 100 is subject to the basic treatment to impart the OH radical to the substrate 100.

The acidic treatment or the basic treatment may be performed by dipping the substrate 100 in an acidic solution or a basic solution.

Referring to FIG. 1b, a photoresist pattern 200 is formed on the hydrophilic substrate 100.

First, a photoresist layer is formed on the substrate 100 through a spin coating process. Then, the photoresist layer is patterned through the lithography process to form the photoresist pattern 200.

The substrate 100 may be partially exposed through the photoresist pattern 200. Thus, the exposed top surface of the substrate 100 may have the hydrophilic property.

Referring to FIG. 1c, a self-assembled monolayer (SAM) 300 is formed on the substrate 100 having the photoresist pattern 200.

The SAM 300 can be formed through the dipping method or the vapor method.

According to the dipping process, a self-assembled mono-molecule solution is prepared by mixing a self-assembled mono-molecule with a solvent and the substrate 100 formed thereon with the photoresist pattern 200 is dipped in the self-assembled mono-molecule solution to form the SAM 300.

The solvent may include toluene, ethylene glycol, or chlorobenzene and the dipping process may be performed for 5 minutes to 10 minutes.

In addition, according to the vapor process, self-assembled mono-molecule vapor is applied to the substrate 100 formed thereon with the photoresist pattern 200 to form the SAM 300.

The self-assembled mono-molecule may include a head group, a hydrocarbon chain and a terminal group.

The head group may include a silane group or a thiol group and may be bonded to the substrate.

The hydrocarbon chain generates van der Waals force between the substrate and the self-assembled mono-molecule or between the self-assembled mono-molecules to allow the self-assembled mono-molecules to form a layer.

In addition, the terminal group includes CH₃ or CF₃ so that the terminal group may have the hydrophobic property.

In detail, the self-assembled mono-molecule may be OTS (octadecyltrichlorosilane) including a chlorosilane group as a head group or HDT (hexadecanethiol) including a thiol group as a head group, but the present invention is not limited thereto.

For instance, if the self-assembled mono-molecule is OTS(CH₃(CH₂)₁₇SiCl₃), the head group and the terminal group of the OTS may be SiCl₃ and CH₃, respectively. When the SAM is formed through the dipping method by using the OTS, the Si—Cl bond in the head group of the OTS may be disconnected through the hydrolysis and the Si—OH bond may be created. In addition, the Si—O—OH bond may be created through the reaction between the SiO₂ substrate and the OH radical. As a result, the SiO₂ substrate is bonded with the OTS, so that the SAM may be formed on the substrate.

The substrate formed with the SAM may be subject to the heat treatment process. The heat treatment process is performed to remove the solvent contained in the SAM. The heat treatment process is performed for 5 minutes to 10 minutes at the temperature in the range of 110° C. to 130° C.

Referring to FIG. 1d, the photoresist pattern 200 is removed to form an SAM pattern 310.

The photoresist pattern 200 may be removed by using acetone. As a result, only the SAM pattern 310 may remain on the substrate 100. Thus, the surface of the SAM pattern 310 may have the hydrophobic property and the surface of the substrate exposed through the SAM pattern 310 may have the hydrophilic property.

Referring to FIG. 1e, a dewetting solution 400 is coated on the substrate 100 formed with the SAM pattern 310. At this time, the dewetting solution 400 is coated only on the hydrophilic surface exposed through the SAM pattern 310 by the primary dewetting phenomenon.

This is because there is difference in surface energy between two different materials. In detail, the surface formed with the SAM patter has a low surface energy and the hydrophilic surface of the substrate, in which the SAM is not formed because it does not make contact with the solution in the dipping process due to the photoresist pattern, has a high surface energy. If the surface energy is high, the surface is thermodynamically unstable, so the dewetting solution 400 is spontaneously coated on the hydrophilic surface having the higher surface energy.

The dewetting solution 400 may be coated through the drop method.

The dewetting solution 400 may include polymer, biomaterial, or metal nano-particle as a solute, but the present invention is not limited thereto.

The polymer may include at least one selected from the group consisting of PMMA (Polymethylmethacrylate), PVA (Polyvinyl Alcohol), PS (Polystyrene), PVP (Polyvinylpyrrolidone), P3HT(poly(3-hexylthiophene)), PQT-12(poly(3,3′-didodecyl-quaterthiophene)), F8T2(poly(9,9′-n-dioctylfluorenealt-bithiophene)) and TIPS-pentacene(6,13 -bis(triisopropyl-silylethynyl) pentacene).

The biomaterial may include at least one selected from the group consisting of nucleic acid, cell, virus, protein, organic molecule, and inorganic molecule.

The metal nano-particle may include at least one selected from the group consisting of Ag, Au, Cu, Pd and Ti.

Meanwhile, the solvent of the dewetting solution 400 may include chloroform, chlorobenzene or DMSO (dimethyl sulfoxide). However, the present invention is not limited thereto, but various types of organic solvents may be employed.

Referring to FIGS. 1f and 1g, if the dewetting solution 400 coated only on the hydrophilic surface is dried, only the solute of the dewetting solution 400 may remain at an edge of the dewetting solution 400 by the secondary dewetting phenomenon, so that a microstructure pattern 410 is formed at the edge.

The driving force of the secondary dewetting phenomenon is the coffee stain effect. If a stain is formed on a surface due to the evaporation of a droplet containing small particles, such as coffee grains, the stain is deeply expressed at an edge thereof rather than the center thereof, which is called the coffee stain effect. That is, the Marangoni flow is created radially outward from the center of the stain to compensate for the loss occurring at the edge where the evaporation is actively generated, so the particles may migrate to the edge along the Marangoni flow.

For instance, if the dewetting solution 400 dropped onto the substrate 100 has a semicircular shape, the evaporation speed of the solvent at the edge of the dewetting solution 400 is faster than the evaporation speed of the solvent at the center of the dewetting solution 400 due to the difference in surface areas between the center and the edge of the dewetting solution 400. Thus, the solvent existing at the edge may be primarily evaporated, and the solution existing at the center may flow toward the edge to compensate for the solvent evaporated at the edge. As time has elapsed, all of the solution existing at the center may flow to the edge, so that the substrate is exposed and the solute remaining at the edge may be hardened in a convex shape, thereby forming the microstructure pattern.

Then, the SAM pattern 310 is removed through the O₂ plasma treatment or the UV ozone treatment, so that only the microstructure pattern 410 may remain on the substrate 410. Hereinafter, the exemplary experimental example will be described such that those skilled in the art can comprehend the present invention. However, the exemplary experimental example is illustrative purpose only and the present invention is not limited thereto.

### Experimental Example

First, a Si substrate was prepared and the surface of the Si substrate was subject to the hydrophilic treatment through the SC-2 treatment.

A photoresist layer was formed on the surface of the substrate, which has been hydrophilic-treated, through a spin coating process, and the photoresist layer was subject to the UV exposure for 3 seconds and the developing process for 30 seconds, thereby forming a photoresist pattern.

Then, an OTS layer was formed on the substrate having the photoresist pattern through the SAM deposition process. In detail, the substrate formed thereon with the photoresist pattern was dipped for about 5 minutes in a container having an OTS solution prepared by mixing 1.5 wt % of OTS with 98.5 wt % of toluene.

Then, the substrate formed with the OTS layer was heat treated. In detail, the heat treatment process was performed for 5 minutes at the temperature of about 100° C., thereby removing the toluene contained in the OTS layer.

After that, the photoresist pattern was removed by using acetone, thereby forming an SAM pattern.

Then, a PMMA solution, which was prepared by dissolving 1 wt % of PMMA in chlorobenzene, was dropped onto the substrate formed with the SAM pattern by using a syringe. After that, the microstructure pattern with two PMMA lines was formed at both edges of a hydrophilic line having a thickness of about 50 μm through the double dewetting edge lithography.

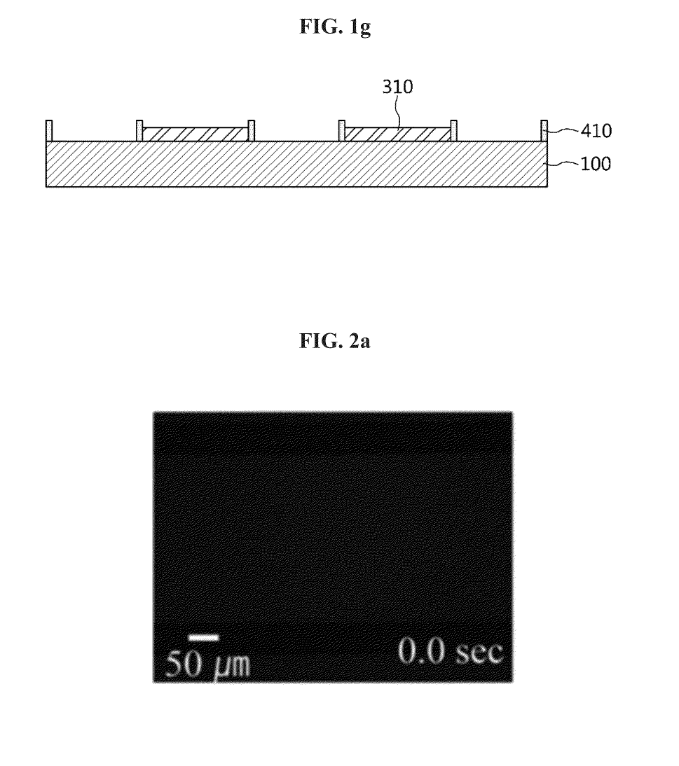

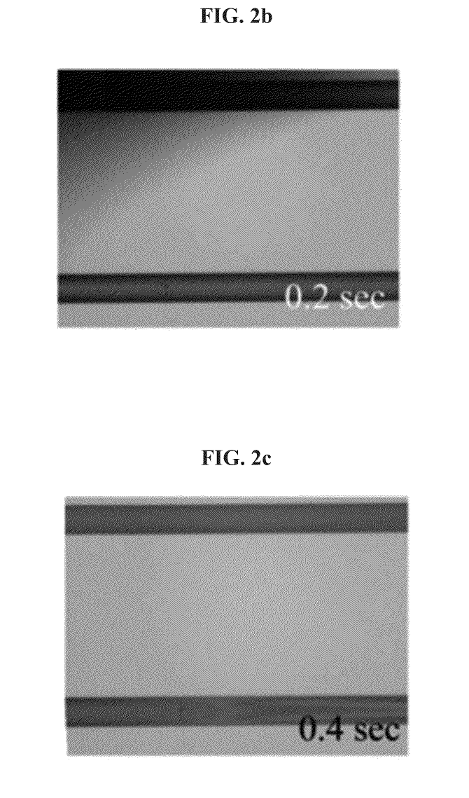

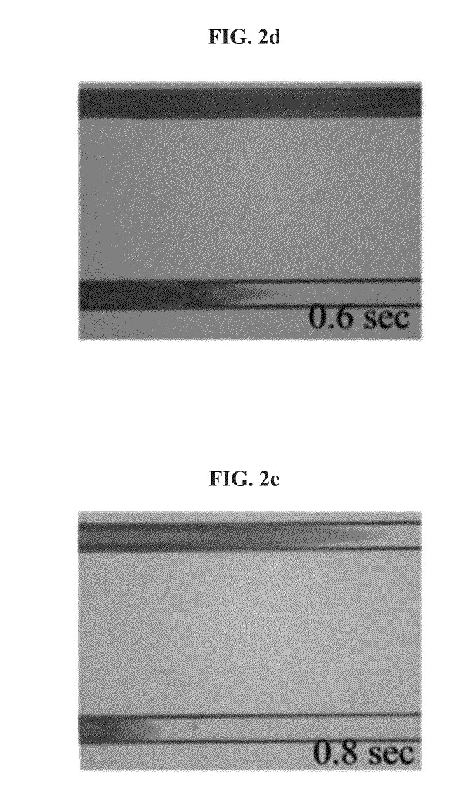

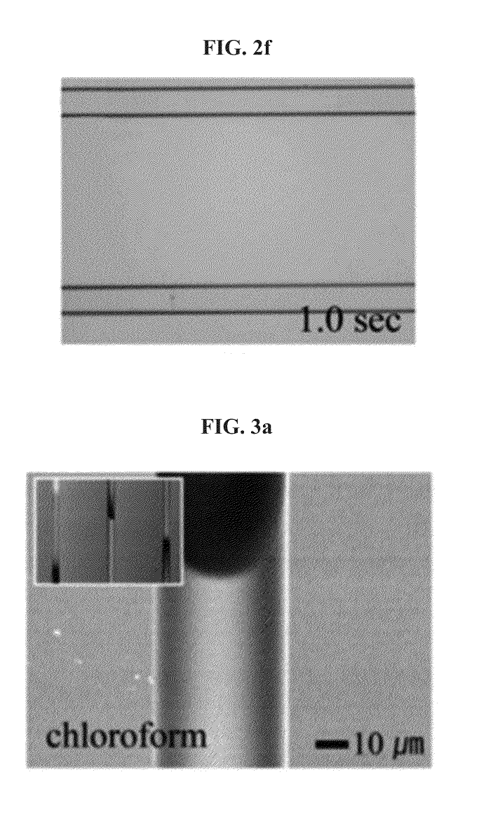

FIGS. 2a to 2f are snapshot images representing a process for forming the microstructure pattern according to one embodiment of the present invention based on the time sequence.

Referring to FIG. 2a, when the reaction time is 0 second, the solution is coated and instantly coagulated on the hydrophilic region.

Referring to FIG. 2b, when the reaction time is 0.2 second, the primary dewetting phenomenon occurs.

Referring to FIG. 2c, when the reaction time is 0.4 second, the PMMA solution is coated only on the hydrophilic line region due to the primary dewetting phenomenon.

Referring to FIG. 2d, when the reaction time is 0.6 second, the coffee stain effect occurs in the PMMA solution, the microstructure pattern is formed at the edge of the PMMA solution and the second dewetting phenomenon occurs.

Referring to FIG. 2e, when the reaction time is 0.8 second, the second dewetting phenomenon is proceeding.

Referring to FIG. 2f, when the reaction time is 1 second, the double dewetting edge lithography process is completed and the microstructure pattern is formed.

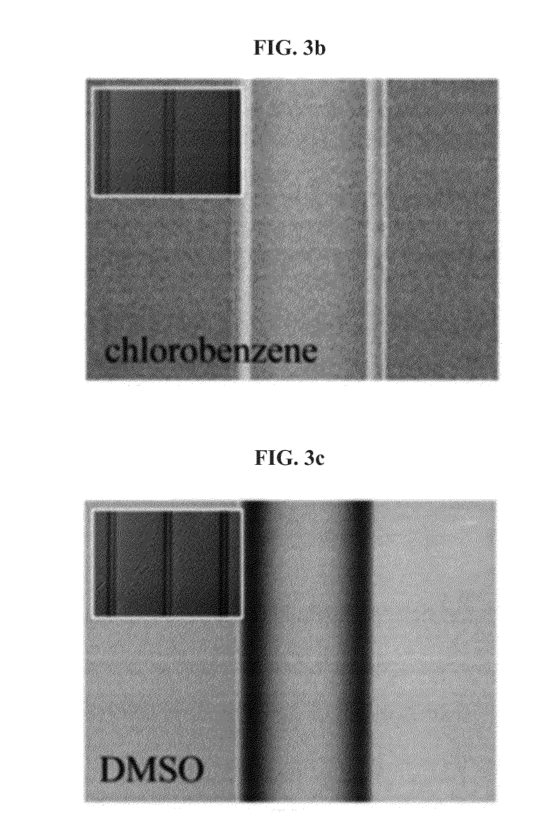

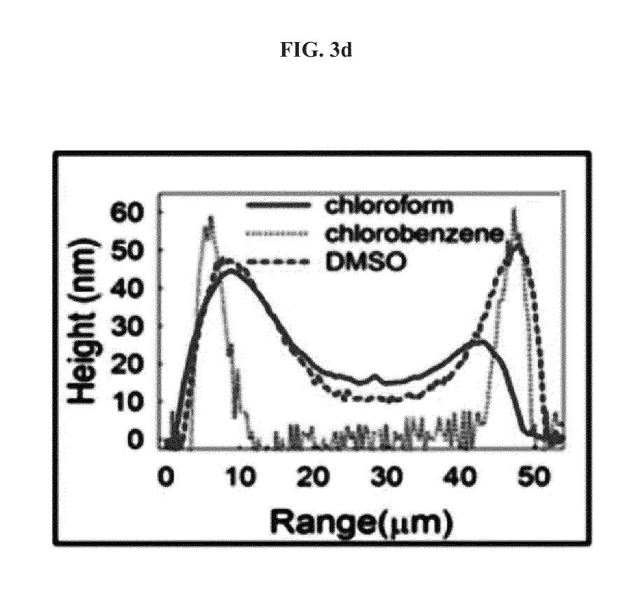

FIGS. 3a to 3d are images and a graph representing the result of a microstructure pattern according to the type of solvent.

Experiment was performed at the normal temperature using the PMMA solution prepared by dissolving 1 wt % of PMMA in various solvents.

Referring to FIGS. 3a and 3d, when chloroform was used as the solvent, the chloroform was very rapidly evaporated, so a residual layer having a thickness of about 20 nm was left because the movement speed of the solute did not match with the evaporation speed of the solvent.

Referring to FIGS. 3b and 3d, when chlorobenzene was used as the solvent, the microstructure pattern having the line width of 5.16 μm and the height of 60 nm was formed. A residual layer was rarely left. This signifies that the movement speed of the solute was well balanced with the evaporation speed of the solvent.

Referring to FIGS. 3c and 3d, when DMSO was used as the solvent, a wider line and a residual layer were observed. Since the boiling point of the DMSO is very high, the solvent was very slowly evaporated, so the driving force to generate the secondary dewetting phenomenon was insufficient.

Thus, if the solvent is too rapidly evaporated, the solvent may not flow toward the edge. In addition, if the solvent is too slowly evaporated, all hydrophilic parts may be filled with the solvent.

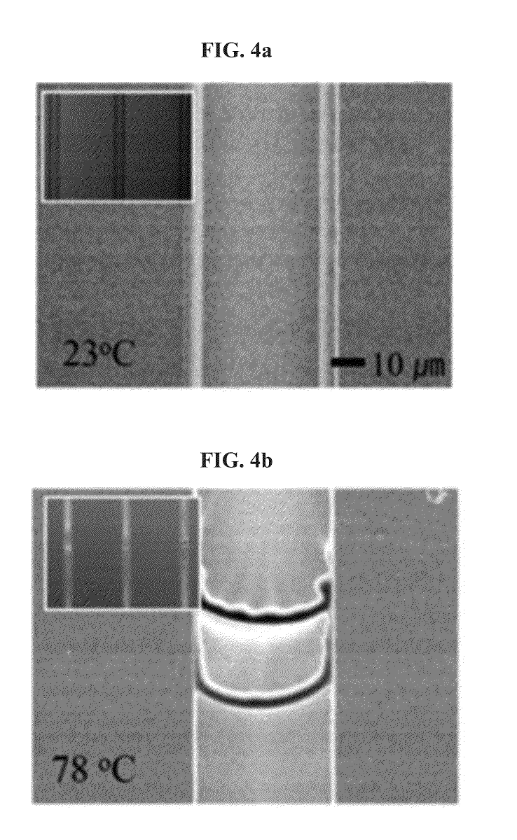

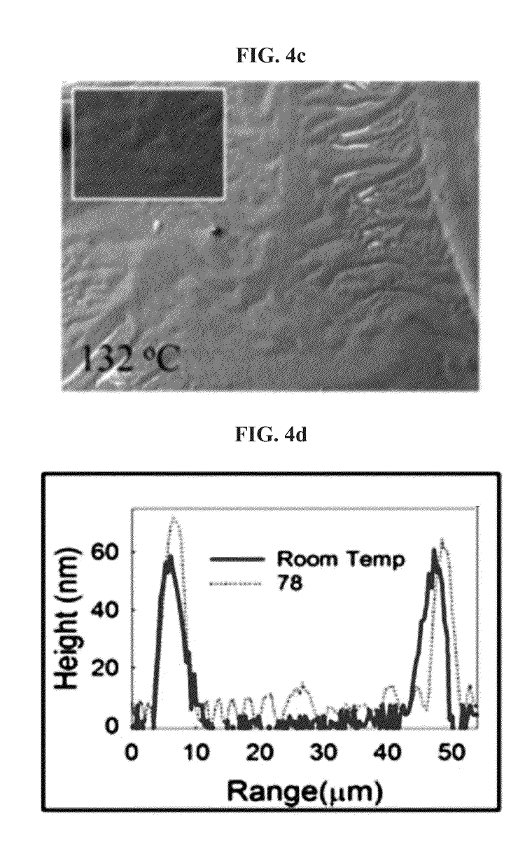

FIGS. 4a to 4d are images and a graph representing the result of a microstructure pattern according to the drying temperature.

Experiment was performed by using the PMMA solution prepared by dissolving 1 wt % of PMMA in chlorobenzene.

Referring to FIGS. 4a and 4d, when the drying process was performed at the normal temperature (about 23° C.), the microstructure was formed. Referring to FIGS. 4b and 4d, when the drying temperature was 78° C., the double dewetting phenomenon occurred, so the micro-line structure was formed without the residual layer. However, the high drying temperature promoted the evaporation of the solvent, so that the undesired stain was formed along the line as shown in FIG. 4b.

Referring to FIGS. 4c and 4d, when the drying temperature was 132° C., which is the boiling point of chlorobenzene (FIG. 4c), the solvent was suddenly evaporated, so the solution may not be sufficiently covered with the hydrophilic solution. Thus, an irregular polymer layer was formed on all substrates.

Thus, the drying temperature of the mixing solution is preferably set to the normal temperature (about 23° C.). If the drying temperature is higher than the normal temperature, the solvent may be hardened before the solvent flows to the edge.

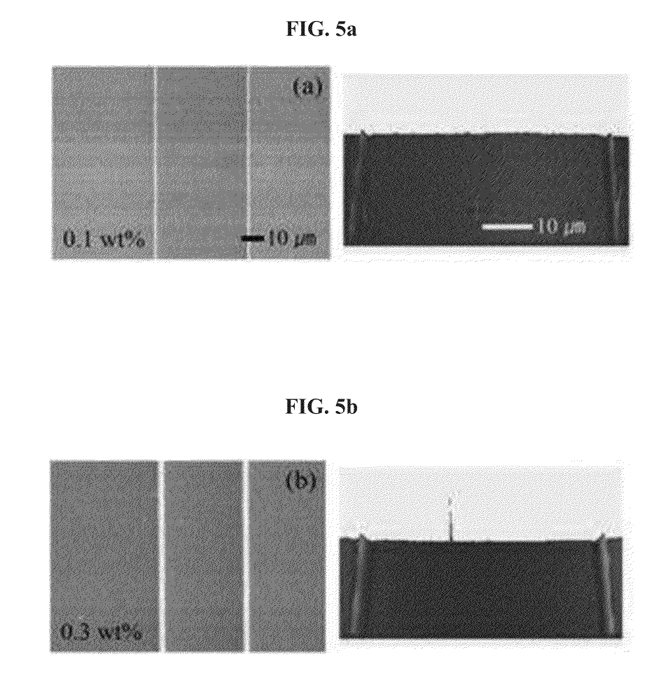

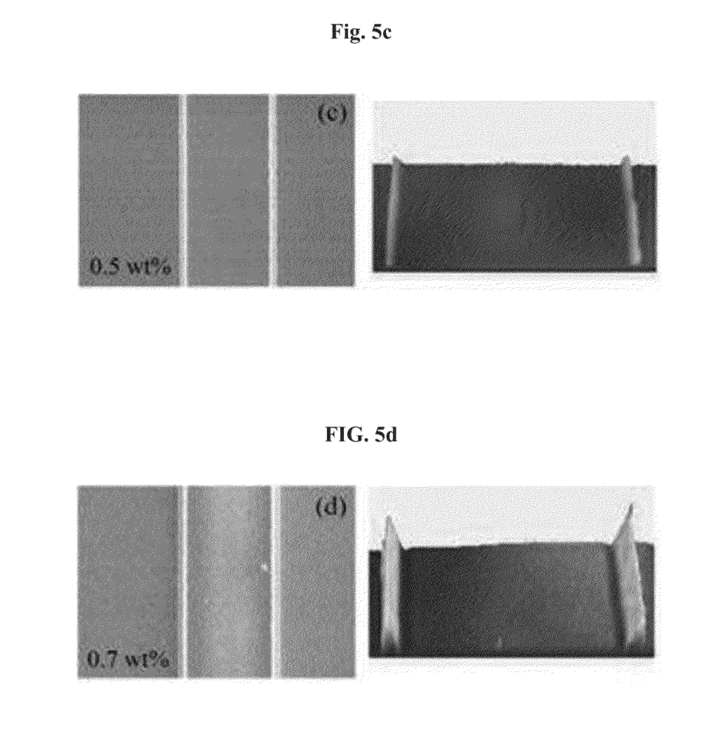

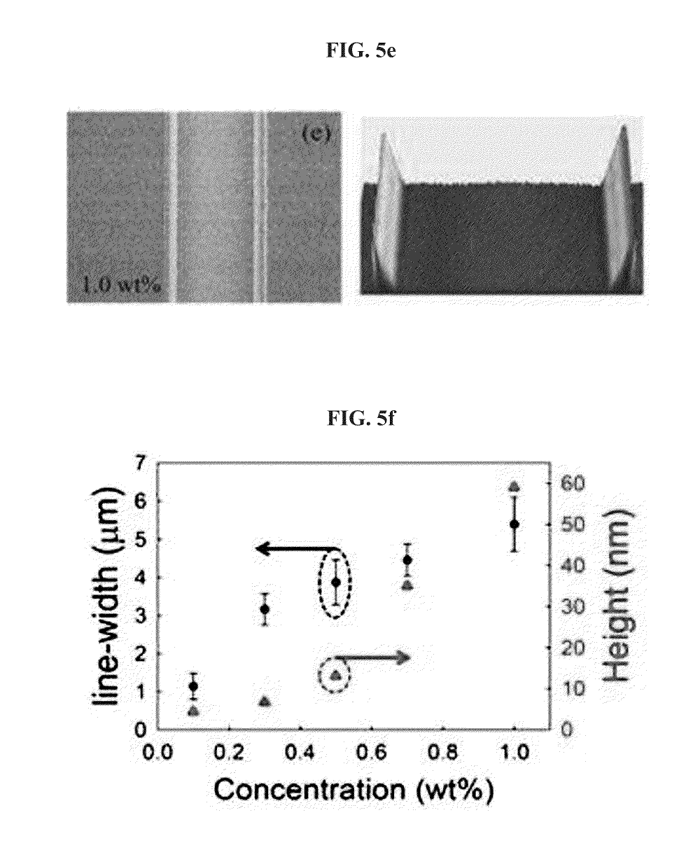

FIGS. 5a to 5f are images and a graph representing the result of a microstructure pattern according to concentration of a solution.

Drawings positioned to the left in FIGS. 5a to 5d are SEM images, and drawings positioned to the right in FIGS. 5a to 5d are AFM (atomic force microscope) surface morphology images corresponding to the SEM images.

As the concentration of the solution was increased, the height of the microstructure pattern was linearly increased. Thus, the height of the microstructure pattern can be controlled by adjusting the concentration of the solution.

When the concentration of the solution was 0.05 wt % (not shown), the microstructure pattern was not formed, and only a dot stain was formed.

As the concentration of the solution was increased, the line width of the microstructure pattern was proportionally increased.

If the concentration of the solution is too high, the center of the hydrophilic region may not be revealed. In addition, if the concentration of the solution is too low, the solvent may not remain.

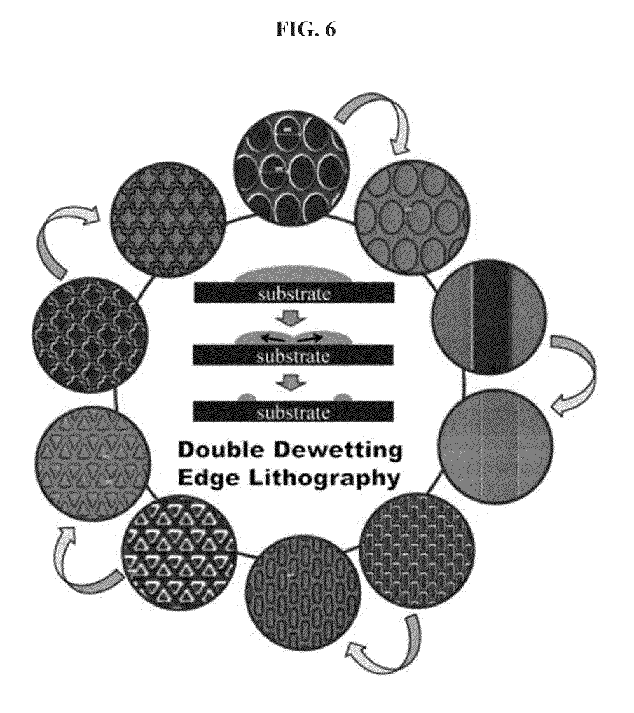

FIG. 6 is an image showing various microstructure patterns formed through the double dewetting edge lithography.

The microstructure pattern was formed using the PMMA solution prepared by dissolving 0.5 wt % of PMMA in chlorobenzene.

Referring to FIG. 6, it is possible to form the microstructure pattern having various structures, such as a ring structure, a right-angle structure, a triangle structure, and a linear structure by using the double dewetting edge lithography.

The double dewetting edge lithography according to the present invention can be utilized in various fields. For instance, the double dewetting edge lithography can be used to manufacture a nano-bio chip including DNA or protein.

In addition, the double dewetting edge lithography can be applied to the transparent electrode field. In detail, the transparent electrode can be manufactured through the double dewetting edge lithography by using a metal solution including gold nano-particles or silver nano particles.

In addition, although LC (liquid crystal) used in an LCD (liquid crystal display) is aligned in one direction by an alignment layer, the LC may be aligned according to the surface structure. Thus, if thin lines are continuously patterned by using the double dewetting edge lithography, the LC can be aligned in one direction without the alignment layer.

Further, if the etching process is performed after patterning the photoresist through the double dewetting edge lithography in the semiconductor manufacturing process, semiconductor devices having the nano-scale structure as well as the microstructure can be manufactured.

Although exemplary embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A method for forming a microstructure pattern, the method comprising:
forming a photoresist pattern on a hydrophilic substrate;
forming a self-assembled monolayer on the hydrophilic substrate formed thereon with the photoresist pattern;
forming a self-assembled monolayer pattern by removing the photoresist pattern;
coating a dewetting solution on the hydrophilic substrate formed thereon with the self-assembled monolayer pattern such that the dewetting solution is coated only on a hydrophilic surface of the hydrophilic substrate exposed through the self-assembled monolayer pattern by primary dewetting; and
drying the dewetting solution coated on the hydrophilic surface of the hydrophilic substrate and allowing the dewetting solution to be hardened after flowing to an edge of the dewetting solution by secondary dewetting such that only a solute of the dewetting solution remains.

2. A method for forming a microstructure pattern, the method comprising:
forming a self-assembled monolayer pattern on a hydrophilic substrate;
coating a dewetting solution on the hydrophilic substrate exposed through the self-assembled monolayer pattern; and
drying the dewetting solution such that only a solute of the dewetting solution remains on a region making contact with the self-assembled monolayer pattern.

3. The method of claim 1, wherein the hydrophilic substrate includes Ag, Au, Cu, Pd, Ti, Si, SiO₂, Al₂O₃ or ITO (Indium Tin Oxide).

4. The method of claim 2, wherein the hydrophilic substrate includes Ag, Au, Cu, Pd, Ti, Si, SiO₂, Al₂O₃ or ITO (Indium Tin Oxide).

5. The method of claim 1, wherein a self-assembled mono-molecule of the self-assembled monolayer pattern includes a silane group or a thiol group as a head group.

6. The method of claim 2, wherein a self-assembled mono-molecule of the self-assembled monolayer pattern includes a silane group or a thiol group as a head group.

7. The method of claim 1, wherein a self-assembled mono-molecule of the self-assembled monolayer pattern includes OTS (octadecyltrichlorosilane) or HDT (hexadecanethiol).

8. The method of claim 2, wherein a self-assembled mono-molecule of the self-assembled monolayer pattern includes OTS (octadecyltrichlorosilane) or HDT (hexadecanethiol).

9. The method of claim 1, wherein the solute of the dewetting solution includes a polymer, a biomaterial or a metal nano-particle.

10. The method of claim 2, wherein the solute of the dewetting solution includes a polymer, a biomaterial or a metal nano-particle.

11. The method of claim 9, wherein the polymer includes at least one selected from the group consisting of PMMA, PVA, PS, PVP, P3HT, PQT-12, F8T2 and TIPS-pentacene.

12. The method of claim 10, wherein the polymer includes at least one selected from the group consisting of PMMA, PVA, PS, PVP, P3HT, PQT-12, F8T2 and TIPS-pentacene.

13. The method of claim 9, wherein the biomaterial includes at least one selected from the group consisting of a nucleic acid, a cell, a virus, a protein, an organic molecule, and an inorganic molecule.

14. The method of claim 10, wherein the biomaterial includes at least one selected from the group consisting of a nucleic acid, a cell, a virus, a protein, an organic molecule, and an inorganic molecule.

15. The method of claim 9, wherein the metal nano-particle includes at least one selected from the group consisting of Ag, Au, Cu, Pd and Ti.

16. The method of claim 10, wherein the metal nano-particle includes at least one selected from the group consisting of Ag, Au, Cu, Pd and Ti.

17. The method of claim 1, wherein the coating of the dewetting solution only on the hydrophilic surface of the hydrophilic substrate is carried out at a normal temperature.

18. The method of claim 2, wherein the coating of the dewetting solution only on the hydrophilic surface of the hydrophilic substrate is carried out at a normal temperature.
